(19) United States
(12) Patent Application Publication
(10) Pub. No.: US 2025/0156234 A1
(43) Pub. Date: May 15, 2025

(54) FRACTIONAL PROCESSING CAPACITY ALLOCATION BASED ON ESTIMATED LOAD

(71) Applicant: Microsoft Technology Licensing, LLC, Redmond, WA (US)

(72) Inventors: Sanjay RAMANUJAN, Sammamish, WA (US); Karthik RAMAN, Sammamish, WA (US); Rakesh KELKAR, Bellevue, WA (US); Anwar SAIPULLA, Redmond, WA (US); Osama ABUELSOROUR, Menlo Park, CA (US); Anthony Christopher KARLOFF, Waltham, MA (US); Christopher W. HODER, Arlington, MA (US); Archit SHUKLA, Belagavi (IN)

(73) Assignee: Microsoft Technology Licensing, LLC, Redmond, WA (US)

(21) Appl. No.: 18/438,996

(22) Filed: Feb. 12, 2024

Related U.S. Application Data
(60) Provisional application No. 63/598,293, filed on Nov. 13, 2023.

(51) Int. Cl. G06F 9/50

(52) U.S. Cl. CPC G06F 9/505; G06F 2209/5019

(57) ABSTRACT

A method for artificial intelligence (AI) inferencing workload allocation includes, at a computing device of a distributed AI inferencing platform, receiving an estimated prompt load and an estimated generation load of an AI inferencing workload to be fulfilled by a processing unit of a computing node of the distributed AI inferencing platform. Based at least in part on the estimated prompt load and the estimated generation load, an inference unit (IU) processing load is estimated, the IU processing load to be applied to the processing unit while fulfilling the AI inferencing workload. Fractional processing capacity of the processing unit is allocated for fulfilling the AI inferencing workload based at least in part on the IU processing load.

### CROSS REFERENCE TO RELATED APPLICATIONS

This application claims priority to U.S. Provisional Patent Application No. 63/598,293, filed Nov. 13, 2023, the entirety of which is hereby incorporated herein by reference for all purposes.

### BACKGROUND

An artificial intelligence (AI) inferencing platform may implement various trained AI models, used to generate outputs in response to input prompts provided by users. Such platforms may use various techniques in an attempt to efficiently allocate different user AI workloads to different processing units within the platform, to thereby optimize the use of processing units, reduce latency, and balance the load across the network.

### SUMMARY

A method for artificial intelligence (AI) inferencing workload allocation includes, at a computing device of a distributed AI inferencing platform, receiving an estimated prompt load and an estimated generation load of an AI inferencing workload to be fulfilled by a processing unit of a computing node of the distributed AI inferencing platform. Based at least in part on the estimated prompt load and the estimated generation load, an inference unit (IU) processing load is estimated, the IU processing load to be applied to the processing unit while fulfilling the AI inferencing workload. Fractional processing capacity of the processing unit is allocated for fulfilling the AI inferencing workload based at least in part on the IU processing load.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing environment.

FIG. 2 schematically illustrates estimation of an estimated prompt load and an estimated generation load based on a sample workload.

FIG. 3 schematically illustrates estimation of an inference unit (IU) processing load based on an estimated prompt load and estimated generation load.

FIG. 4 schematically illustrates allocation of input prompt groups to different graphics processing unit (GPU) batches.

FIGS. 5A and 5B depict plots of inferencing latency under different workload allocation conditions.

FIG. 6 schematically illustrates allocation of different user workloads to an artificial intelligence (AI) inferencing model.

FIGS. 7A and 7B schematically illustrate timing of inferencing forward passes performed by a computing device.

FIG. 8 shows an example AI model workload capacity calculator interface.

FIG. 9 shows an example AI model deployment interface.

FIG. 10 shows an example AI model utilization monitoring interface.

FIG. 11 illustrates an example method for AI inferencing workload allocation.

FIG. 12 schematically shows an example computing system.

### DETAILED DESCRIPTION

A distributed artificial intelligence (AI) inferencing platform can be used to provide different AI models for vision, speech, language, decision-making, and/or other suitable modalities, and make such models available to users for inferencing. In some examples, the users are customers of the distributed AI inferencing platform. Such a platform may allow users to create their own AI models, which can be hosted on the platform and used to perform inferencing on user-provided data. Additionally, or alternatively, the platform may host various pre-trained models. Models accessible through the inferencing platform may include Large Language Models (LLMs), speech models, image models, various multimodal models including traditional machine learning models, and/or any other suitable machine-learning (ML) or AI models.

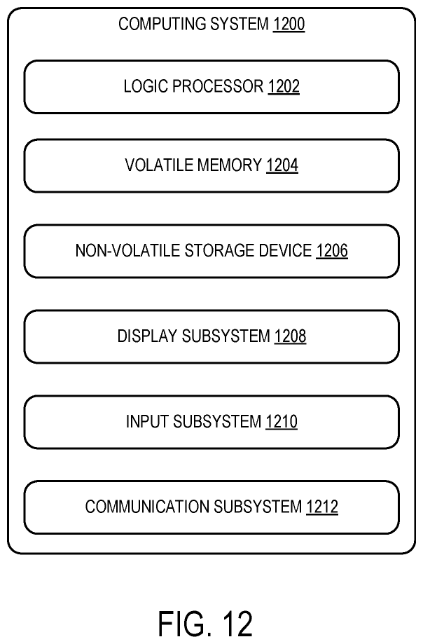

The models are executed by suitable computer logic hardware, such as via a plurality of different processing units distributed between a plurality of computing nodes of the distributed AI inferencing platform. The present disclosure primarily describes the processing units used to execute the AI models and perform inferencing on user-provided input prompts as being graphics processing units (GPUs). In other words, in some examples, a processing unit is a graphics processing unit. It will be understood, however, that this is not limiting-any suitable computer logic hardware may be used. In some examples, the computing devices used to instantiate the distributed AI inferencing platform are implemented as computing system 1200 described below with respect to FIG. 12.

As used herein, a “workload” refers to a set of one or more input prompts provided to the distributed AI inferencing platform for inferencing over time. It can be challenging to coordinate resource sharing between different users—e.g., to distribute different user workloads between the different processing units in a manner that provides stable and consistent performance for each user. In one approach, different users may purchase or otherwise acquire a desired number of Provisioned Throughput Units (PTUs), which represent inferencing capacity that user can use to fulfill their inferencing workloads. As an example, some users who desire a predictable and dedicated inferencing capacity can purchase capacity equivalent to a single GPU or GPU batch. However, once issued, this capacity typically cannot be used by other users, which can contribute to resource stranding and potential lost revenue for the owner of the distributed AI inferencing platform.

For users that do not need a dedicated capacity and/or are more price conscious, another option includes providing such users with access to a shared pool with a rate limiter in place. However, some users end up exhausting their token processing limit, and performance can be impacted during periods of high utilization—e.g., when the available compute resources of the pool are saturated by other user workloads. This can be referred to as a “noisy neighbor” phenomenon, where one user's latency is negatively affected by the fact that utilization of the shared pool by other users is currently high.

As such, the present disclosure describes techniques for AI model workload allocation that can provide fractional reserved processing capacity. In other words, users may be assigned fractional capacity allocations that represent a fraction of the total capacity of a single processing unit. This may enable a distributed AI inferencing platform to provide consistent latency and throughput performance for user workloads, particularly for workloads with stable characteristics such as prompt and completion size and number of concurrent requests.

However, providing such consistent performance can pose various challenges. Users may bring a wide variety of different workloads to the distributed AI inferencing platform. These workloads can be classified as different types including, for example, generation-heavy, prompt-heavy, and balanced workloads. These combinations lead to varying latencies. Some prompts can be similar in nature, allowing the model to internally optimize token generation, while other workloads bring in very disparate prompts. Users can request multiple completions for the same prompt, and/or provide multiple prompt arrays for the same request. Both impact the total processing load associated with fulfilling the workload. Some users may send datasets requesting a streaming response focused on low latency time-to-first token, while other users may provide non-streaming workloads that emphasize throughput and overall lower execution time. Additional factors that can affect AI model performance include model fine-tuning functionality (e.g., providing users with the capability to fine-tune models for a specific context), changes in hardware performance over time (e.g., due to hardware updates), and/or compliance with data privacy and responsible AI standards.

Accordingly, the present disclosure describes techniques for predicting the processing unit capacity (e.g., GPU capacity) that will be used for fulfilling a given user workload. In general, input prompts of a user workload are formatted as some number of input tokens, where each input token corresponds to a word, series of characters, single character, or other subdivision of the input prompt. The input tokens expressing an input prompt are input to an AI model, which generates a response to the input prompt in the form of output tokens. In other words, the processing load used to fulfill a given workload is proportional both to the number of input tokens provided to the AI model, and also proportional to the number of output tokens generated by the model.

As such, the processing load to be used for a given workload may be predicted based on a sample workload with a certain distribution of input and output tokens, allowing the system to achieve predictable performance for similar user workloads. In general, the system may estimate the prompt load (e.g., processing load associated with interpreting input tokens) and generation load (e.g., processing load associated with generating output tokens) for a given workload. This may be used to estimate an inference unit (IU) processing load, representative of the overall processing load that will be placed on the processing unit while fulfilling the user's workload. Based on the IU processing load, fractional processing capacity of a processing unit may be allocated for fulfilling the workload.

In some examples, the techniques described herein can provide one or more of: a capability to predict fractional GPU capacity for a given workload to achieve service-level agreement (SLA) requirements; a capability to abstract physical hardware resources and networking topology to determine performance characteristics of AI models; an ability to understand the impact of different workloads on these AI models without conducting extensive benchmarking or proof of concepts; an ability to model additional sensitivity analysis by adding information (such as expected cache hit rate and/or prompt tuning) that influences the token generation rate; and/or an intelligent system that can recommend an ideal model and GPU cluster configuration to run a workload without human intervention.

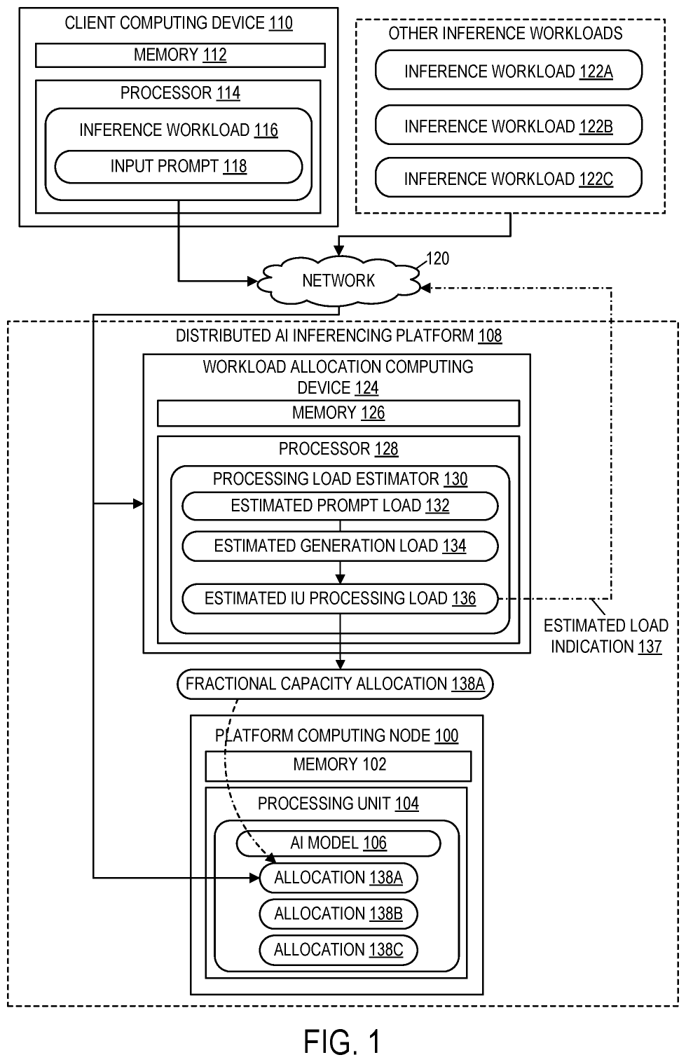

FIG. 1 schematically shows an example computing environment in which any or all of the herein-described techniques may be implemented. The computing environment includes a platform computing node 100, which can be used to fulfill user workloads by executing AI models to generate outputs in response to user input prompts. As one example, computing node 100 takes the form of a server computer. Computing node 100 includes a memory 102 and processing unit 104, which are used to implement an AI model 106. In some examples, the same computing node includes multiple processing units—e.g., a batch of GPUs-which may be used to fulfill any suitable number of different AI workloads concurrently. It will be understood that a “processing unit” may refer to any suitable computer logic hardware. As non-limiting examples, processing units may include central processing units (CPUs), GPUS, application-specific integrated circuits (ASICs), field-programmable gate arrays (FPGAs), and/or other suitable computer logic hardware.

As shown, the computing device is a component of a distributed AI inferencing platform 108 that is implemented by a plurality of different computing devices. In general, computing device 100, as well as the other computing devices described herein, has any suitable capabilities, hardware configuration, and form factor. Any or all of the computing devices described herein may in some cases be implemented as computing system 1200 described below with respect to FIG. 12.

As used herein, an AI model is “implemented” by a computing device when parameters of the AI model are stored by, or otherwise accessible to, the computing device, such that the AI model can be executed by the processor of the computing device. This may include loading model parameters into random access memory (RAM) of the computing device, memory of a graphics processing unit (GPU), memory of a central processing unit (CPU), and/or other suitable volatile or non-volatile memory. The same computing device may implement any suitable number and variety of different AI models. In some examples, one or more of the AI models implemented by the computing device are instantiated via different virtual machines or containers hosted on the computing device. For instance, in one embodiment, each different AI model is instantiated in a different virtual machine or container hosted by the computing device.

In FIG. 1, a client computing device 110 is communicatively coupled with the distributed AI inferencing platform, and sends AI inference workloads to the distributed AI inferencing platform for fulfillment. The client computing device may, for instance, be owned, operated, or otherwise associated with a user or customer of the distributed AI inferencing platform. As shown, client computing device 110 includes a memory 112 and a processor 114, which are used to generate an inference workload 116. The inference workload includes an input prompt 118, which is to be provided to a selected AI model implemented by a computing device of the distributed AI inferencing platform to generate an output. The input prompt takes the form of any data suitable for input to the AI models for inference. As non-limiting examples, the input prompt may be an encoded representation of text data (e.g., a natural language input typed, spoken, or otherwise provided by a human user), image data (e.g., for image classification or facial recognition), audio data (e.g., for speech recognition), and/or video data.

The inference workload is transmitted to the distributed AI inferencing platform via a computer network 120. This takes the form of any suitable local or wide-area computer network, such as the Internet. As shown, the distributed AI inferencing platform additionally receives a plurality of other inference workloads 122A-C, which originate from other computing devices. It will be understood that the distributed AI inferencing platform may receive any suitable number of inference requests from any suitable number of different client computing devices, which may correspond to one or more different users of the distributed AI inferencing platform. For instance, in one scenario, the distributed AI inferencing platform is used by thousands or millions of different customers, each of whom pay for access to the hardware resources of the distributed AI inferencing platform, and each of whom provide inference workloads to the platform for fulfillment.

As discussed above, in some examples, the distributed AI inferencing platform is implemented by a plurality of different computing devices (e.g., server computers) working cooperatively. Different computing devices may, for instance, host different AI models, and/or have different hardware capabilities suitable for fulfilling different types of workloads. In FIG. 1, only one platform computing node is shown, although it will be understood that this is non-limiting. Rather, the distributed AI inferencing platform may include any suitable number of different computing nodes, each of which may include any suitable number of different processing units (e.g., GPUs) for fulfilling user AI inferencing workloads.

Thus, as discussed above, the distributed AI inferencing platform may allocate received inference workloads between different computing nodes and processing units according to any suitable criteria. In FIG. 1, this is performed by a workload allocation computing device 124, which includes a memory 126 and a processor 128. The workload allocation computing device implements a processing load estimator 130, which is used to estimate the relative processing load that will be used to fulfill a given inference workload. The computing device receives an estimated prompt load 132 and an estimated generation load 134 of an AI inferencing workload (e.g., inference workload 116) to be fulfilled by a processing unit of a computing node (e.g., platform computing node 100) of the distributed AI inferencing platform.

As will be described in more detail below, the estimated prompt load and estimated generation load are “received” in any suitable way, from any suitable source. In some examples, “receiving” the estimated prompt load and estimated generation load may include calculating either or both of the estimated prompt load and estimated generation load based on characteristics of the AI inferencing workload, and/or based on characteristics of a sample workload. Additionally, or alternatively, the estimated prompt load and/or estimated generation load may be specified by the user supplying the AI inferencing workload.

In any case, based at least in part on the estimated prompt load and the estimated generation load, the workload allocation computing device estimates an inference unit (IU) processing load 136 to be applied to the processing unit while fulfilling the AI inferencing workload. As will be described in more detail below, the IU processing load may be estimated in various suitable ways, based on any suitable input data. As one non-limiting example, the IU processing load may be estimated using a statistical model.

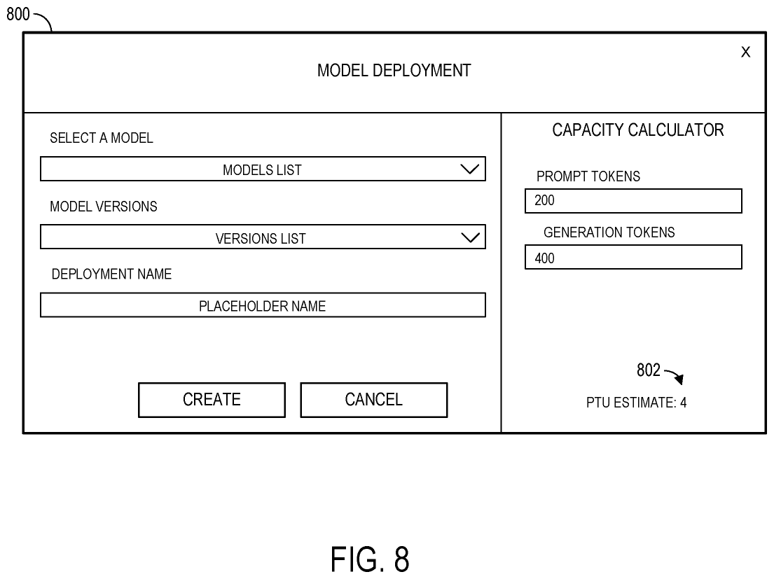

In some examples, the estimated IU processing load may be output for additional processing and/or review. For instance, in some examples, the workload allocation computing device may transmit an indication of the IU processing load for display in a graphical user interface (GUI). One example GUI will be described below with respect to FIG. 8. This may, for instance, enable customers and/or operators of the distributed AI inferencing platform to understand the impact that a given AI inferencing workload will have during fulfillment—e.g., the amount of processing load used to fulfill the workload, and/or the amount of money that may be charged to fulfill such a workload. In the example of FIG. 1, the workload allocation computing device transmits an estimated load indication 137 over network 120, and thereby delivers such an indication to any relevant entities (such as client computing device 110).

Once the IU processing load is estimated, the computing device allocates fractional processing capacity of the processing unit for fulfilling the AI inferencing workload based at least in part on the IU processing load. In FIG. 1, the workload allocation computing device determines a fractional capacity allocation 138A based on the estimated IU processing load. As shown, this corresponds to a fractional portion of the processing capacity of processing unit 104 of platform computing node 100. This fractional capacity is then used to fulfill inference workload 116—e.g., to generate output data in response to input prompt 118. Such output data may then be output for review and/or further processing. In some examples, the size of the fractional capacity allocation relative to a total processing capacity of the processing unit (e.g., the percentage of the total capacity of the processing unit assigned for fulfillment of a given workload) is proportional to the estimated IU processing load.

It will be understood that the output data may be “output” in various suitable ways depending on the implementation. In some embodiments, outputting the output data includes passing the output data to a downstream application (e.g., for decoding), transmitting the output data to another computing device (e.g., to a client computing device, to another computing device of a distributed AI inferencing platform), writing the output data to a data file, storing the output data in non-volatile storage of the computing device, and/or storing the output data in an external storage device communicatively coupled with the computing device.

In FIG. 1, fractional capacity allocation 138A is generated for inference workload 116. In some examples according to the techniques described herein, additional processing capacity of the processing unit may be allocated for concurrently fulfilling one or more other AI inferencing workloads. For instance, in FIG. 1, additional fractional capacity allocations 138B and 138C of processing unit 104 may be assigned to other inference workloads—e.g., any of the other inference workloads 122A-C. In other words, the fractional capacity allocation 138A may be allocated as a first fractional capacity allocation, and a second fractional capacity allocation of the processing unit may be allocated for concurrently fulfilling a second AI inferencing workload associated with a different user. This beneficially improves the performance of the computing system by reducing the risk that unused capacity of a processing unit is “stranded” and therefore unavailable for use. Rather, in this case, unused fractional capacity may be assigned to fulfill other inferencing workloads, which is equivalent to an improvement in the processing capability of the processing unit.

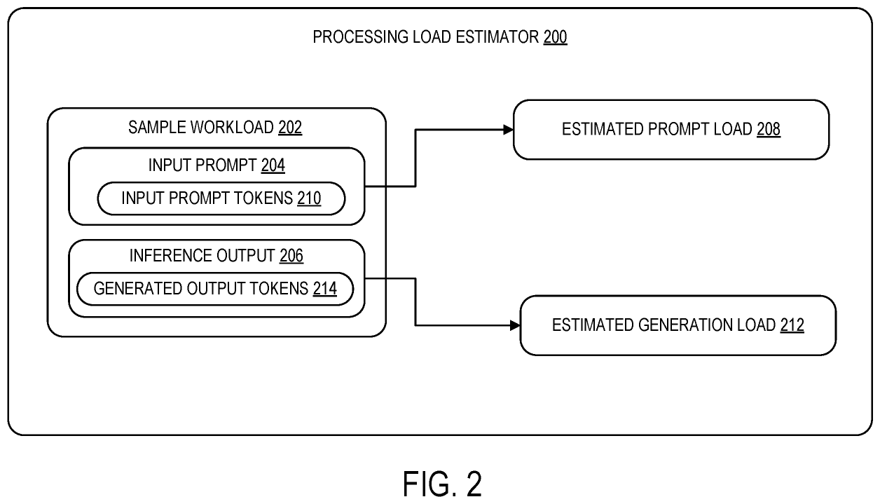

Estimation of an estimated prompt load and an estimated generation load (e.g., such as prompt load 132 and generation load 134 shown in FIG. 1) is schematically illustrated with respect to FIG. 2. Specifically, FIG. 2 schematically shows an example processing load estimator 200, which may be implemented by any suitable computing device (e.g., workload allocation computing device 124 of FIG. 1). As shown, in this example, the processing load estimator has received a sample workload 202. In general, the sample workload may have similar workload characteristics (e.g., in terms of input prompts and/or generated output prompts) to the AI inferencing workload for which fractional processing capacity is being allocated.

The sample workload may have any suitable source. In some examples, the sample workload is provided by the same user that also provided the AI inferencing workload for which fractional processing capacity is being allocated. For instance, the sample workload may include curated input prompts and corresponding output data that the user believes will be representative of future AI inferencing workloads that they expect to provide to the distributed AI inferencing platform. Additionally, or alternatively, the sample workload may include previous input prompts provided to the distributed AI inferencing platform in a prior inferencing request associated with the same user as the AI inferencing workload. In other words, the sample workload may include inference workloads previously fulfilled by the distributed AI inferencing platform for the user—e.g., prior to the user switching to a fractional allocation model.

Characteristics of the sample workload may be used to calculate the estimated prompt load and/or generation load in any suitable way. In the example of FIG. 2, the sample workload includes at least one input prompt 204 and at least one inference output 206 corresponding to the input prompt 204. The estimated prompt load 208 may be estimated based at least in part on an input prompt token quantity of a sample workload associated with a same user as the AI inferencing workload. For instance, input prompt 204 includes a quantity of input tokens 210, and the estimated prompt load 208 may be proportional to the quantity of input tokens 210. Similarly, the estimated generation load may be estimated based at least in part on a quantity of output tokens generated for the sample workload. Thus, the estimated generation load 212 may be proportional to a quantity of generated output tokens 214 of inference output 206.

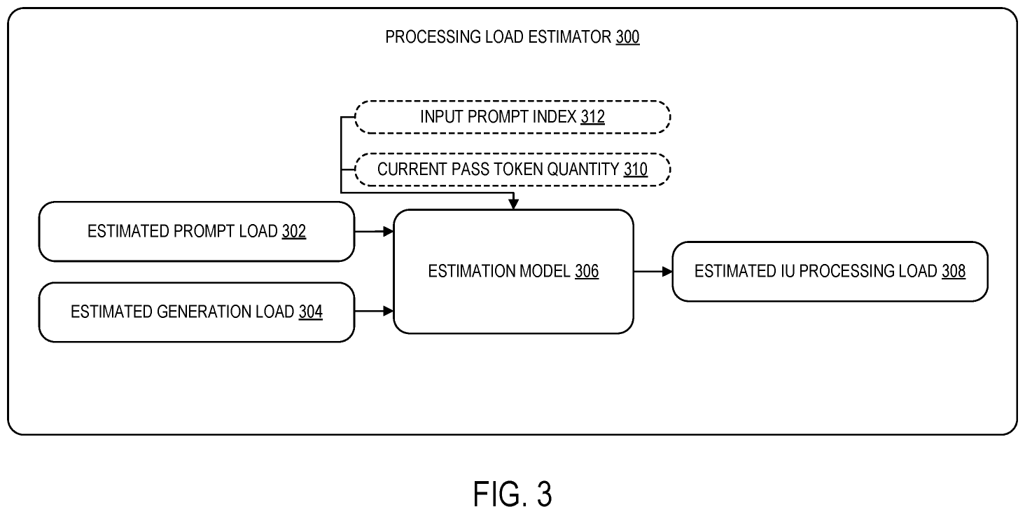

Estimation of an IU processing load is schematically illustrated with respect to FIG. 3. Specifically, FIG. 3 schematically shows another example processing load estimator 300, which may be implemented by any suitable computing device (e.g., workload allocation computing device 124 of FIG. 1). As shown, the processing load estimator has received an estimated prompt load 302 and an estimated generation load 304. These may be received and/or calculated in any suitable way—e.g., estimated based on a sample workload as discussed above, and/or specified by a user. Using a suitable estimation model 306, the processing load estimator estimates an IU processing load 308.

The IU processing load may be estimated in any suitable way depending on the implementation, using any suitable type of estimation model. As one non-limiting example, the IU processing load may be estimated using a statistical model. Any suitable statistical model may be used. In some examples, the statistical model is a linear regression model. However, it will be understood that this need not only be done via linear regression-rather, as other examples, suitable boosted tree models, mathematical models, and/or trained models (e.g., a trained machine learning model that outputs an IU load estimate based on prompt and generation load) may be used to estimate the IU load for a given workload.

In some cases, the estimation model used to derive the IU processing load may be generated based on a current-pass token quantity and an input prompt index. In FIG. 3, a current pass token quantity 310 and an input prompt index 312 are used to derive the estimation model 306. The current-pass token quantity refers to the number of input tokens input to the AI model in a given forward pass. The input prompt index refers to the quantity of input tokens that have previously been input to the model as of the current forward pass. These may be used to estimate the total amount of time used to input and process each input token of an input prompt—e.g., a sample input prompt of a sample workload. Thus, the current-pass token quantity and the input prompt index may be used to estimate an amount of time used to process each input token of a sample input prompt. The IU processing load is proportional to the amount of time used to process each input token of the sample input prompt—e.g., if this time is longer, and/or if more input tokens are included, then the total processing load will be higher. By simulating a number of different workloads having different input token quantities (e.g., prompt load) and output token quantities (e.g., generation load), a relationship can be derived that approximates IU processing load based on the estimated prompt load and the estimated generation load.

The present disclosure has thus far primarily focused on a single inference workload, for which fractional capacity of one processing unit is allocated. However, as discussed above, the distributed AI inferencing platform may be implemented by any suitable number of different computing nodes (e.g., thousands of different server computers), each of which may include any suitable number of different processing units (e.g., GPU batches). Thus, the techniques described herein may be used to allocate a wide variety of different workloads to a plurality of different processing units, which may themselves be distributed between a plurality of different computing nodes of the distributed AI inferencing platform.

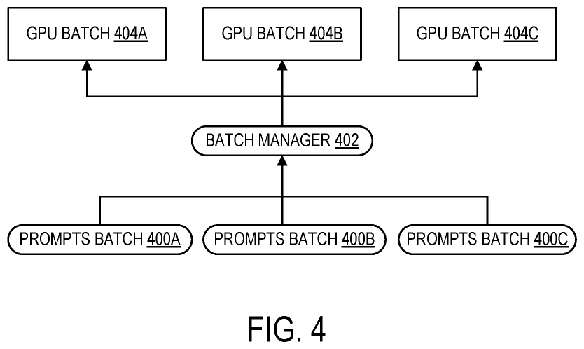

This process, referred to as “batch allocation,” is schematically illustrated with respect to FIG. 4. In FIG. 4, batches of input prompts 400A, 400B, and 400C are input to a batch manager 402, which allocates such input prompts to different batches of GPUs (and/or other suitable processing units) 404A, 404B, and 404C. The input prompt batches may include prompts from any suitable number of one or more different AI inferencing workloads, which may correspond to any suitable number of different users. A “batch manager” may be implemented as any suitable physical and/or virtual entity that assigns inferencing workloads to different processing units—e.g., according to the fractional capacity allocation techniques described herein. A “GPU batch” may include any suitable number of GPUs and/or other suitable processing units, which may be distributed between one or more different computing devices. For instance, in some examples, a GPU batch is a server computing device that includes one or more GPUs.

FIG. 4 will now be used to explain one example scenario where different prompt batches are allocated to different GPU batches based on their estimated IU processing loads. In general, a GPU batch has a finite capacity to generate tokens during inferencing in a given time period (e.g., 3000 output tokens). For the sake of explanation, it will be assumed that users intend for their output tokens to be delivered once all tokens are generated—e.g., tokens are not continuously streamed. However, it will be understood that the techniques described herein may be applied in scenarios where output tokens are streamed to the user as they are generated.

In this example scenario, prompts batch 400A includes a set of ten prompts that are 500 tokens long and cause generation of 200 output tokens each. Each GPU batch in this example has a finite capacity of generating 3000 output tokens, and thus GPU batch 404A can handle the ten prompts of batch 400A (e.g., accounting for 2000 output tokens). Prompts group 400B has a set of 20 prompts that are 2000 tokens long and cause generation of 100 output tokens each (this may be referred to as a “prompt-heavy” dataset). Half of these are assigned to GPU batch 404A (e.g., accounting for 1000 output tokens) to balance its token capacity, and the remainder of prompts batch 400B goes to GPU batch 404B (accounting for another 1000 output tokens). Prompt batch 400C has a set of 40 prompts that are 100 tokens long and cause generation of 500 output tokens each (this may be referred to as a “generation-heavy” dataset). Four of these input prompts (e.g., accounting for 2000 output tokens) are assigned to GPU batch 404B to balance its capacity, and another six input prompts (e.g., accounting for 3000 output tokens) are assigned to GPU batch 404C. Any unassigned input prompts may be rejected with an error indicating that the system is at capacity and cannot process additional prompts.

Various metrics may be used to illustrate performance characteristics of the above system. Time-to-first token (TTFT): This measures the time to generate the first token that is sent to the user. This can be particularly relevant for streaming requests, where the user expects the AI model to continuously send tokens as they are generated. As a corollary, time-to-last token (TTLT) is the time to generate the last token in the response.

Time-between-tokens (TBT): This measures the time between tokens during the token generation process. With rising load, TBT degrades, and generation rate reduces at high load. TBT is relevant for both streaming and non-streaming requests.

$$TBT = \frac{( TTLT - TTFT )}{( {tokens}_{generated} )}$$

Utilization: Once all the GPU batches are at full token generation capacity with no more new batches possible (e.g., due to memory constraints), the system is at full utilization and any additional load may be rejected. In some examples, it is possible for the user to send a retry request once the load reduces to get a subsequent response via their client.

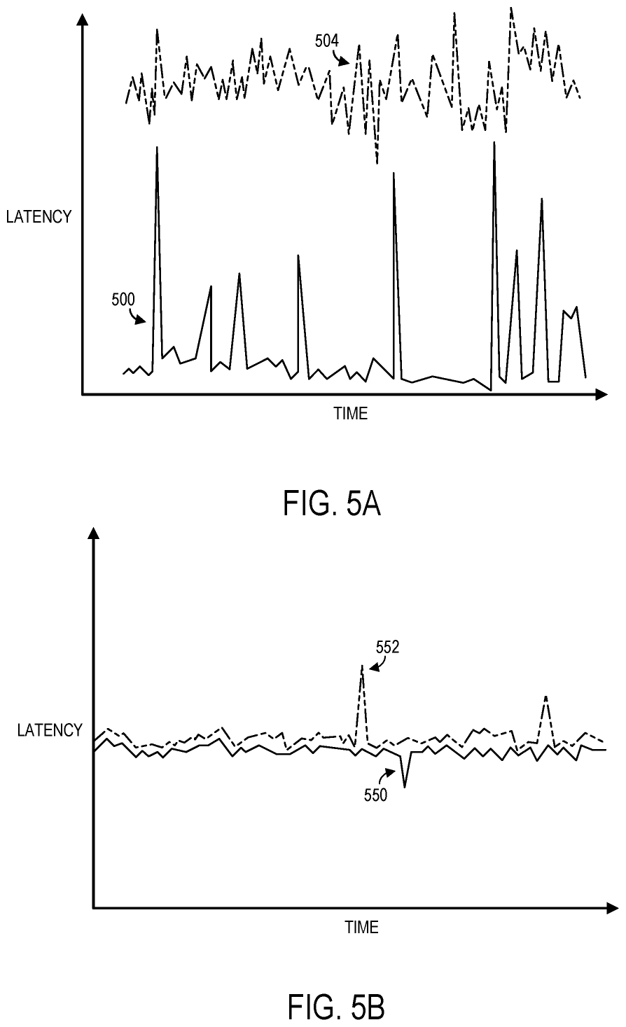

Latency variation: As load increases, and the GPU batches approach their generation capacity, TBT will no longer stay in a steady state. This is shown in FIG. 5A. Specifically, FIG. 5A shows plots 500 and 502 depicting inference latency values over time during a period of high utilization. Plot 500 corresponds to the P50 latency values, while plot 502 corresponds to the P95 latency values.

Prompt load: In some examples, such as cases where the input prompt has a relatively large number of input tokens, the index of the prompt can be relevant. For instance, TTFT when the prompt token size is 200 versus 20,000 can be vastly different. In other words, TTFT is proportional to the prompt load, which in turn is proportional to the number of input tokens in the AI inferencing workload, as discussed above. In this manner, for “prompt-heavy” workloads (e.g., those with a relatively large number of input tokens for inferencing), prompt load is higher, and TTFT is higher. In some examples, prompts are read sequentially but generation is parallelized up to the number of threads that can be spawned, which in turn is a function of available memory in the hardware. The prompt load for a given workload (e.g., a sample user workload) can be estimated by simulating different scenarios where different numbers of input tokens are provided to the same model, with the same output and batch sizes. Additionally, or alternatively, the prompt load may be derived from a user indication of the predicted number of input tokens that will be included in a typical input prompt.

Generation load: the TBT for a given workload increases with an increasing number of generated tokens. In other words, TBT is proportional to the generation load, which is the processing load applied to the GPUs during generation of output tokens as discussed above. This may arise from the nature of the workload itself and/or the number of concurrent requests. TBT can be non-linear, especially at higher utilization of the GPUs (e.g., as is shown in FIG. 5A). The generation load for a given workload may similarly be estimated by simulating different scenarios where different characteristic input prompts are provided to the same model, with the same batch sizes. Additionally, or alternatively, the generation load may be derived from a user indication of the predicted number of output tokens that will be generated in response to a typical user prompt.

IU processing load: Inference requests that cause generation of a relatively large number of tokens typically have a higher generation load. This can be exacerbated when the prompt load is also relatively high, causing a significant overall IU processing load. In other words, the IU load to fulfill a given inference request is based at least in part on the prompt token length, TTFT, TBT, and/or the expected number of generated tokens. To estimate the IU load, a set of simulations may be run with varying prompt and generation sizes at various utilization capacities (e.g., request concurrency impacts the load placed on the GPUs), while measuring the latency impact. In this manner, for a given AI model:

IU Load∝(Prompt load+Generation load+error)

This may be used to estimate the running inference-per-minute (IUPM) load of incoming requests that are going into the GPU.

Stable performance: Using the above relationship, it is possible to estimate the IU processing load that will be applied to GPUs of the distributed AI inferencing platform while fulfilling the user's AI inferencing workload. In some examples, a maximum batch size may be enforced. In some examples, the predicted IU load and maximum batch size may be set such that the stability for a given workload is improved, while latency is reduced. For instance, FIG. 5B shows plots 550 and 552 of inferencing latency over time, in a scenario where utilization is relatively high but workloads are allocated according to estimated IU processing load as described herein. Plot 550 depicts P50 latency values and plot 552 depicts P95 latency values. As compared to FIG. 5A, latency values in FIG. 5B are relatively more stable.

Fractional capacity: The IU processing load estimation function can be used to provide an IU processing load calculator, enabling allocation of fractional GPU capacity as a function of incoming prompt load and generation load. This means that, given a user workload (e.g., prompt-heavy, generation-heavy, or balanced), it is possible to estimate the associated IU processing load. As such, GPU capacity can be provisioned as a logical unit, which may be referred to as a PTUv2 (Provisioned-Managed Throughput Unit), also referred to as a “PTU” for simplicity.

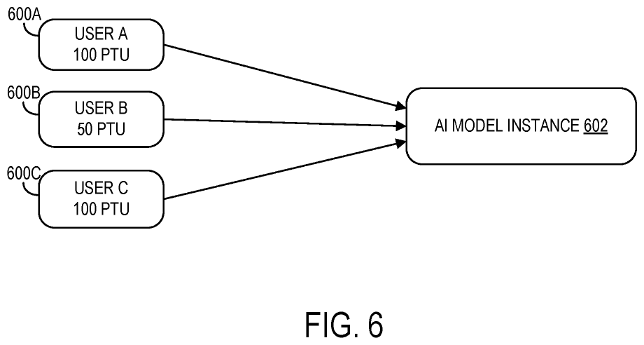

FIG. 6 schematically illustrates an example scenario where different users 600A-C are allocated different numbers of PTUs for fulfilling user workloads at a single AI model instance 602 (e.g., implemented by one or more different GPUs), based on the number of IUs each workload is estimated to use. As one non-limiting example, the AI model instance may be a generative pre-trained transformer (GPT) model, such as GPT-4. However, it will be understood that any suitable AI and/or machine learning (ML) models may be used. As additional non-limiting examples, an AI model instance may take the form of the LLaMa 2 model, the Claude 2 model, the Stable Diffusion model, or the MPT-7B model. In some cases, the AI model instance may be a custom model provided and/or trained by the user. In any case, after estimating the IU load for a given user (e.g., based on information reported by the user and/or a sample workload provided by the user), the user may be allocated fractional GPU capacity based on the IU processing load.

Running at a defined Provisioned-Managed Throughput can help to reduce the cost for a user, while improving the stability and reducing the latency with which the user's workloads are fulfilled. In some examples, if a user requires additional GPU capacity, they can then purchase additional PTUs as fractional GPU capacity. Notably, the remaining GPU capacity is available to fulfill other user workloads. In this manner, different workloads can be isolated from one another, which improves stability and reduces the impact that one user workload may have on other, concurrently fulfilled workloads. This can reduce the impact of “noisy neighbors”—e.g., scenarios where one user's workload is negatively impacted by the fact that resources of a shared pool are consumed by other user workloads.

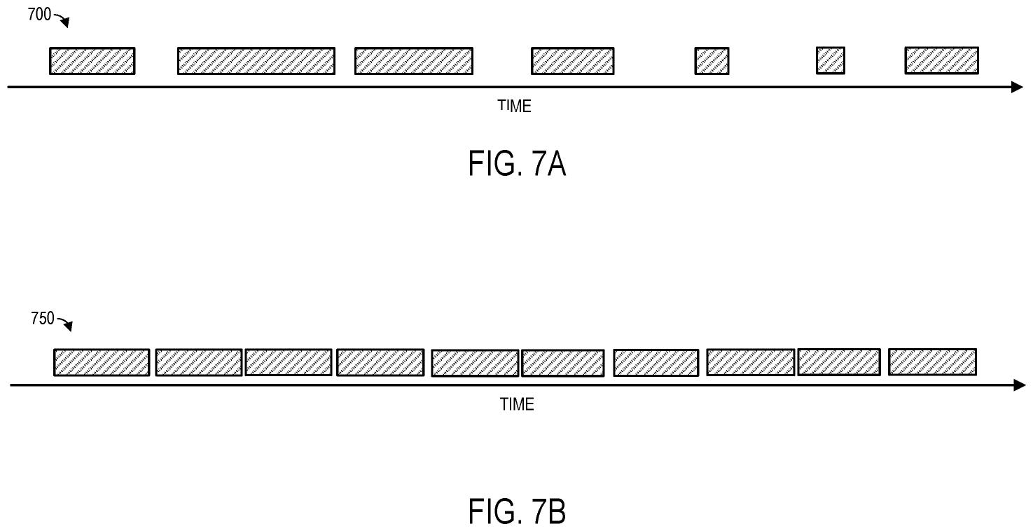

In some examples, provisioning fractional GPU capacity in this manner can reduce GPU idle time, effectively increasing GPU utilization. FIG. 7A schematically represents GPU utilization in a scenario where fractional GPU allocation is not performed. Specifically, FIG. 7A shows a sequence 700 of cells, each cell representing the amount of time spent by a processing unit in a forward inferencing pass to generate a token. As shown, this approach results in a relatively large amount of idle time for the processing unit. By contrast, FIG. 7B schematically represents another sequence 750 of cells, each cell again representing the amount of time spent in each forward inferencing pass. However, in this scenario, fractional processing capacity is allocated based on estimated IU processing load, as described above. As shown, the forward passes are more tightly packed, resulting in less idle time and improved utilization.

FIG. 8 shows an example interface 800 that may be presented to a user of the distributed AI inferencing platform when deploying an AI model to fulfill AI inferencing workloads. As shown, the interface includes an option to estimate the processing load that may be used in fulfilling the user's workloads, based at least in part on the number of prompt tokens and generation tokens. This may enable users to estimate the costs their workloads are likely to incur. Specifically, as shown, interface 800 includes an IU processing load estimate 802, indicating that the user's workload is expected to require four PTUs.

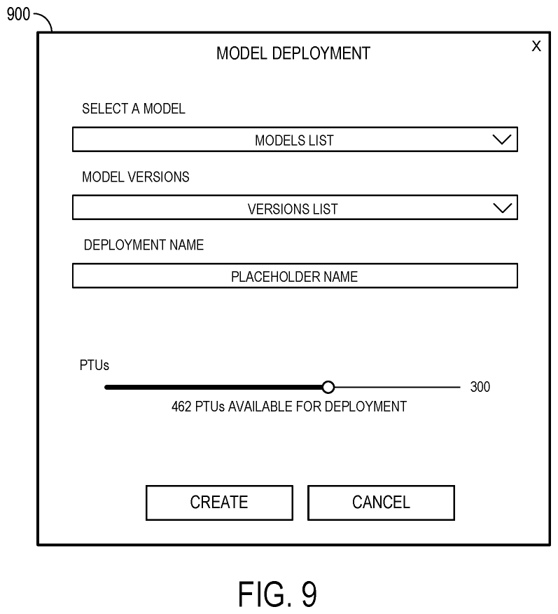

FIG. 9 shows another example interface 900 that may be presented to a user during model deployment. As shown, this interface indicates the number of PTUs that the user has available for deployment, and an option for the user to choose how many PTUs they would like to associate with this model instance.

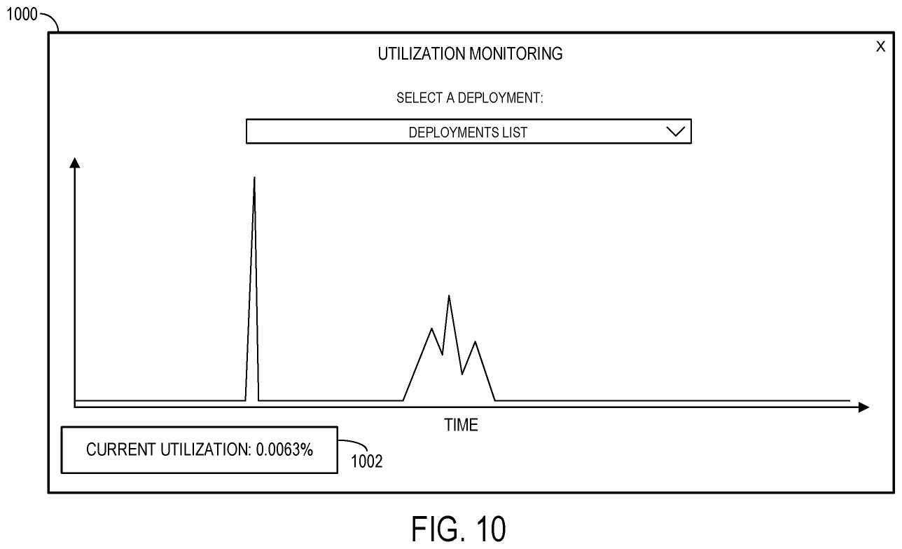

FIG. 10 shows another example interface 1000 that may be presented to a user of the distributed AI inferencing platform. This interface enables the user to monitor their PTU usage over time. In other words, in some examples, the distributed AI inferencing platform outputs an indication of the observed inferencing load used while fulfilling the AI inferencing workload. In other words, while fulfilling the AI inferencing workload, the distributed AI inferencing platform may monitor the amount of processor capacity actually being used (e.g., expressed in PTUs or another suitable unit), and provide an indication of this observed inferencing load to the user. In FIG. 10, this takes the form of an indication 1002 displayed via the interface 1000. It will be understood, however, that such an indication may take any suitable form and may be expressed in any suitable way. Furthermore, such indications may be reported with any suitable degree of granularity. For instance, in some examples, the distributed AI inferencing platform outputs a deployment-level processing load summary indicating a deployment-level processing load used for fulfilling inferencing requests provided to the AI model. Such a summary may be generated in any suitable way—e.g., by monitoring the observed processing load over time for multiple different AI models deployed by the user. In the example of FIG. 10, interface 1000 allows users to select between different deployments managed by the platform, enabling the user to understand the PTU cost of any of their deployments. Indication 1002 is one non-limiting example of a deployment-level PTU summary.

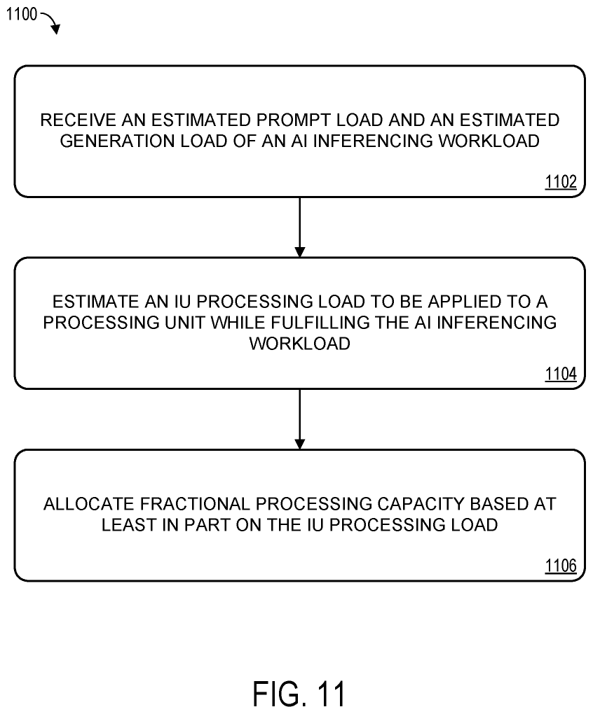

FIG. 11 illustrates an example method 1100 for AI inferencing workload allocation. Method 1100 may be implemented by any suitable computing system of one or more computing devices. Any computing device implementing steps of method 1100 may have any suitable capabilities, hardware configuration, and form factor. Steps of method 1100 may be initiated, terminated, and/or looped at any suitable time and in response to any suitable trigger. As non-limiting examples, method 1100 may be implemented by workload allocation computing device 124 of FIG. 1 or computing system 1200 described below with respect to FIG. 12.

At 1102, method 1100 includes receiving an estimated prompt load and an estimated generation load of an AI inferencing workload. As discussed above, “receiving” the estimated prompt load and/or estimated generation load may include receiving indications of these values from a user, and/or calculating these values based on characteristics of the input workload to be fulfilled. For instance, as described above with respect to FIG. 2, the prompt load and/or generation load may be estimated based on characteristics of a sample workload.

At 1104, method 1100 includes estimating an IU processing load to be applied to a processing unit while fulfilling the AI inferencing workload. As discussed above with respect to FIG. 3, the IU processing load may be estimated using any suitable estimation model. As one non-limiting example, the IU processing load may be estimated using a statistical model, such as a linear regression model.

At 1106, method 1100 includes allocating fractional processing capacity of a processing unit based at least in part on the estimated IU processing load. In this manner, fractional capacity of the same processing unit can be used to concurrently fulfill multiple different user inferencing workloads.

To summarize, the techniques described herein can provide various technical improvements over other approaches to allocating processing capacity for inference requests. For instance, some approaches use a first-in-first-out (FIFO) queue and are memory bound. In such cases, regardless of the size of the incoming request, the system allocates the workload to a GPU batch based on the order in which it was received. By contrast, in the approach described herein, the system estimates the compute cost in IUs to process the request, based at least in part on the estimated prompt load and the estimated generation load. In some examples, this need not abide by a simple FIFO order, but rather can accept other requests in the incoming queue that may have lower IU load while rejecting the requests with higher loads.

The techniques described herein can improve performance stability and reduce latency by utilizing fractional GPU capacity in AI model inferencing. Users may reserve model inferencing capacity to run inferencing on high volume- and/or latency-sensitive workloads. The cost of an inferencing request may be estimated in IUs, which may be used to allocate fractional GPU capacity. For instance, IUs may be mapped to PTUs (e.g., in a one-to-one mapping, or other suitable mapping), which may be purchased by customers of the distributed AI inferencing platform. This can beneficially provide consistent latency and throughput for workloads with consistent characteristics, such as prompt token size, completion size, and concurrent requests. Notably, as discussed, fractional allocations of the same processing unit are isolated from one another, such that one user's workload is not negatively affected by another user's workload fulfilled on the same processing node (e.g., avoiding the “noisy neighbor” phenomenon described above). In other words, in some examples, the AI inferencing workload is fulfilled with an inferencing latency and an inferencing latency variability that is isolated from other AI inferencing workloads concurrently fulfilled by the processing unit. Once allocated, PTUs can be used by users to create AI model deployments on the platform. PTUs are logical constructs that are independent of the underlying hardware infrastructure and network topologies.

For Provisioned-Managed deployments, users can monitor the number of PTUs used at any given time. This deterministic approach may simplify capacity planning and deployment monitoring while providing consistent latency and lower costs for the users. This beneficially simplifies the application development process and enhances user experience by providing flexibility to scale up or down as needed without the constraints of a rigid quota system. On the platform side, it simplifies the complexities of managing AI models and meeting user needs.

The techniques described herein can additionally provide an ability to understand the impact of different workloads on different AI models, without conducting extensive benchmarking or proof of concepts. For instance, in some examples, estimating the IU processing load for inferencing requests supplied to a particular selected AI model may include estimating workload-related performance characteristics for the selected AI model. This may beneficially reduce GPU idle time and improve utilization. Fractional GPU capacity of the same GPU batch can be allocated to different users, where different user workloads are isolated from one another and do not cause significant performance impacts for one another. Additional sensitivity analysis may be modeled by adding information (e.g., expected cache hit rate, prompt customization) that influences the token generation rate.

In some examples, users may be provided with an IU calculator that can estimate the amount of GPU capacity (e.g., in PTUs) that will be consumed by the user's workloads. In some examples, the system may provide a recommendation module that monitors a user's resource usage over time, and then suggests a number of PTUs that should be provisioned by the user to run their workloads while reducing costs and reducing latency. As one example, allocating fractional processing capacity of the processing unit may include predicting that a financial cost to the user of fulfilling the AI inferencing workload using the fractional processing capacity is less than a financial cost to the user of fulfilling the AI inferencing workload under the shared pool allocation plan. For instance, in some examples, a “sample workload” used to estimate prompt load and/or generation load may include input prompts previously submitted by the user to the distributed AI inferencing platform, even if such prompts were submitted before the user took advantage of fractional GPU capacity allocation. For instance, in one example, the sample workload may include a prior inferencing request provided to the distributed AI inferencing platform under a shared pool allocation plan.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 12 schematically shows a non-limiting embodiment of a computing system 1200 that can enact one or more of the methods and processes described above. Computing system 1200 is shown in simplified form. Computing system 1200 may embody the computing system described above and illustrated in FIG. 1. Components of computing system 1200 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 1200 includes a logic processor 1202 volatile memory 1204, and a non-volatile storage device 1206. Computing system 1200 may optionally include a display subsystem 1208, input subsystem 1210, communication subsystem 1212, and/or other components not shown in FIG. 12.

Logic processor 1202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 1202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1206 includes one or more physical devices configured to hold instructions executable by the logic processors to implement the methods and processes described herein. When such methods and processes are implemented, the state of non-volatile storage device 1206 may be transformed—e.g., to hold different data.

Non-volatile storage device 1206 may include physical devices that are removable and/or built in. Non-volatile storage device 1206 may include optical memory, semiconductor memory, and/or magnetic memory, or other mass storage device technology. Non-volatile storage device 1206 may include nonvolatile, dynamic, static, read/write, read-only, sequential-access, location-addressable, file-addressable, and/or content-addressable devices. It will be appreciated that non-volatile storage device 1206 is configured to hold instructions even when power is cut to the non-volatile storage device 1206.

Volatile memory 1204 may include physical devices that include random access memory. Volatile memory 1204 is typically utilized by logic processor 1202 to temporarily store information during processing of software instructions. It will be appreciated that volatile memory 1204 typically does not continue to store instructions when power is cut to the volatile memory 1204.

Aspects of logic processor 1202, volatile memory 1204, and non-volatile storage device 1206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1200 typically implemented in software by a processor to perform a particular function using portions of volatile memory, which function involves transformative processing that specially configures the processor to perform the function. Thus, a module, program, or engine may be instantiated via logic processor 1202 executing instructions held by non-volatile storage device 1206, using portions of volatile memory 1204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1208 may be used to present a visual representation of data held by non-volatile storage device 1206. The visual representation may take the form of a graphical user interface (GUI). As the herein described methods and processes change the data held by the non-volatile storage device, and thus transform the state of the non-volatile storage device, the state of display subsystem 1208 may likewise be transformed to visually represent changes in the underlying data. Display subsystem 1208 may include one or more display devices utilizing virtually any type of technology. Such display devices may be combined with logic processor 1202, volatile memory 1204, and/or non-volatile storage device 1206 in a shared enclosure, or such display devices may be peripheral display devices.

When included, input subsystem 1210 may comprise or interface with one or more user-input devices such as a keyboard, mouse, touch screen, camera, or microphone.

When included, communication subsystem 1212 may be configured to communicatively couple various computing devices described herein with each other, and with other devices. Communication subsystem 1212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 1200 to send and/or receive messages to and/or from other devices via a network such as the Internet.

In an example, a method for artificial intelligence (AI) inferencing workload allocation comprises: at a computing device of a distributed AI inferencing platform, receiving an estimated prompt load and an estimated generation load of an AI inferencing workload to be fulfilled by a processing unit of a computing node of the distributed AI inferencing platform; based at least in part on the estimated prompt load and the estimated generation load, estimating an inference unit (IU) processing load to be applied to the processing unit while fulfilling the AI inferencing workload; and allocating fractional processing capacity of the processing unit for fulfilling the AI inferencing workload based at least in part on the IU processing load. In this example or any other example, the estimated prompt load is estimated based at least in part on an input prompt token quantity of a sample workload associated with a same user as the AI inferencing workload. In this example or any other example, the estimated generation load is estimated based at least in part on a quantity of output tokens generated for the sample workload. In this example or any other example, the sample workload includes a previous input prompt provided to the distributed AI inferencing platform in a prior inferencing request associated with the same user as the AI inferencing workload. In this example or any other example, a current-pass token quantity and an input prompt index are input to a statistical model to estimate an amount of time used to process each input token of a sample input prompt, and wherein the IU processing load is proportional to the amount of time used to process each input token of the sample input prompt. In this example or any other example, the fractional processing capacity of the processing unit is allocated as a fractional capacity allocation, and wherein a size of the fractional capacity allocation relative to a total processing capacity of the processing unit is proportional to the IU processing load. In this example or any other example, the fractional processing capacity is allocated as a first fractional capacity allocation, and wherein a second fractional capacity allocation of the processing unit is allocated for concurrently fulfilling a second AI inferencing workload associated with a different user. In this example or any other example, the AI inferencing workload is fulfilled with an inferencing latency and an inferencing latency variability that is isolated from other AI inferencing workloads concurrently fulfilled by the processing unit. In this example or any other example, the method further comprises outputting an indication of an observed inferencing load used while fulfilling the AI inferencing workload. In this example or any other example, the AI inferencing workload is fulfilled by an AI model deployed in the distributed AI inferencing platform, and wherein the method further comprises outputting a deployment-level processing load summary indicating a deployment-level processing load used for fulfilling inferencing requests provided to the AI model. In this example or any other example, the AI inferencing workload is associated with a selected AI model, and wherein estimating the IU processing load includes estimating workload-related performance characteristics for the selected AI model. In this example or any other example, the method further comprises transmitting an indication of the IU processing load for display in a graphical user interface (GUI).

In an example, a computing device comprises: a processor; and a storage device holding instructions executable by the processor to: receive an estimated prompt load and an estimated generation load of an AI inferencing workload to be fulfilled by a processing unit of a computing node of a distributed AI inferencing platform; based at least in part on the estimated prompt load and the estimated generation load, estimate an inference unit (IU) processing load to be applied to the processing unit while fulfilling the AI inferencing workload; and allocate fractional processing capacity of the processing unit for fulfilling the AI inferencing workload based at least in part on the IU processing load. In this example or any other example, the estimated prompt load is estimated based at least in part on an input prompt token quantity of a sample workload associated with a same user as the AI inferencing workload. In this example or any other example, the estimated generation load is estimated based at least in part on a quantity of output tokens generated for the sample workload. In this example or any other example, the sample workload includes a previous input prompt provided to the distributed AI inferencing platform in a prior inferencing request associated with the same user as the AI inferencing workload. In this example or any other example, the fractional processing capacity is allocated as a first fractional capacity allocation, and wherein a second fractional capacity allocation of the processing unit is allocated for concurrently fulfilling a second AI inferencing workload associated with a different user. In this example or any other example, the instructions are further executable to transmit an indication of the IU processing load for display in a graphical user interface (GUI). In this example or any other example, the fractional processing capacity of the processing unit is allocated as a fractional capacity allocation, and wherein a size of the fractional capacity allocation relative to a total processing capacity of the processing unit is proportional to the IU processing load.

In an example, a method for artificial intelligence (AI) inferencing workload allocation comprises: at a computing device of a distributed artificial intelligence (AI) inferencing platform, estimating an estimated prompt load and an estimated generation load of an AI inferencing workload to be fulfilled by a processing unit of a computing node of the distributed AI inferencing platform, based at least in part on a sample workload associated with a same user as the AI inferencing workload; based at least in part on the estimated prompt load and the estimated generation load, estimating an inference unit (IU) processing load via a statistical model, the IU processing load to be applied to the processing unit while fulfilling the AI inferencing workload; and allocating fractional processing capacity of the processing unit for fulfilling the AI inferencing workload based at least in part on the IU processing load.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for artificial intelligence (AI) inferencing workload allocation, the method comprising:
at a computing device of a distributed AI inferencing platform, receiving an estimated prompt load and an estimated generation load of an AI inferencing workload to be fulfilled by a processing unit of a computing node of the distributed AI inferencing platform;
based at least in part on the estimated prompt load and the estimated generation load, estimating an inference unit (IU) processing load to be applied to the processing unit while fulfilling the AI inferencing workload; and
allocating fractional processing capacity of the processing unit for fulfilling the AI inferencing workload based at least in part on the IU processing load.

2. The method of claim 1, wherein the estimated prompt load is estimated based at least in part on an input prompt token quantity of a sample workload associated with a same user as the AI inferencing workload.

3. The method of claim 2, wherein the estimated generation load is estimated based at least in part on a quantity of output tokens generated for the sample workload.

4. The method of claim 2, wherein the sample workload includes a previous input prompt provided to the distributed AI inferencing platform in a prior inferencing request associated with the same user as the AI inferencing workload.

5. The method of claim 1, wherein a current-pass token quantity and an input prompt index are input to a statistical model to estimate an amount of time used to process each input token of a sample input prompt, and wherein the IU processing load is proportional to the amount of time used to process each input token of the sample input prompt.

6. The method of claim 1, wherein the fractional processing capacity of the processing unit is allocated as a fractional capacity allocation, and wherein a size of the fractional capacity allocation relative to a total processing capacity of the processing unit is proportional to the IU processing load.

7. The method of claim 1, wherein the fractional processing capacity is allocated as a first fractional capacity allocation, and wherein a second fractional capacity allocation of the processing unit is allocated for concurrently fulfilling a second AI inferencing workload associated with a different user.

8. The method of claim 1, the AI inferencing workload is fulfilled with an inferencing latency and an inferencing latency variability that is isolated from other AI inferencing workloads concurrently fulfilled by the processing unit.

9. The method of claim 1, further comprising outputting an indication of an observed inferencing load used while fulfilling the AI inferencing workload.

10. The method of claim 9, wherein the AI inferencing workload is fulfilled by an AI model deployed in the distributed AI inferencing platform, and wherein the method further comprises outputting a deployment-level processing load summary indicating a deployment-level processing load used for fulfilling inferencing requests provided to the AI model.

11. The method of claim 1, wherein the AI inferencing workload is associated with a selected AI model, and wherein estimating the IU processing load includes estimating workload-related performance characteristics for the selected AI model.

12. The method of claim 1, further comprising transmitting an indication of the IU processing load for display in a graphical user interface (GUI).

13. A computing device, comprising:
a processor; and
a storage device holding instructions executable by the processor to:
receive an estimated prompt load and an estimated generation load of an AI inferencing workload to be fulfilled by a processing unit of a computing node of a distributed AI inferencing platform;
based at least in part on the estimated prompt load and the estimated generation load, estimate an inference unit (IU) processing load to be applied to the processing unit while fulfilling the AI inferencing workload; and
allocate fractional processing capacity of the processing unit for fulfilling the AI inferencing workload based at least in part on the IU processing load.

14. The computing device of claim 13, wherein the estimated prompt load is estimated based at least in part on an input prompt token quantity of a sample workload associated with a same user as the AI inferencing workload.

15. The computing device of claim 14, wherein the estimated generation load is estimated based at least in part on a quantity of output tokens generated for the sample workload.

16. The computing device of claim 14, wherein the sample workload includes a previous input prompt provided to the distributed AI inferencing platform in a prior inferencing request associated with the same user as the AI inferencing workload.

17. The computing device of claim 13, wherein the fractional processing capacity is allocated as a first fractional capacity allocation, and wherein a second fractional capacity allocation of the processing unit is allocated for concurrently fulfilling a second AI inferencing workload associated with a different user.

18. The computing device of claim 13, wherein the instructions are further executable to transmit an indication of the IU processing load for display in a graphical user interface (GUI).

19. The computing device of claim 13, wherein the fractional processing capacity of the processing unit is allocated as a fractional capacity allocation, and wherein a size of the fractional capacity allocation relative to a total processing capacity of the processing unit is proportional to the IU processing load.

20. A method for artificial intelligence (AI) inferencing workload allocation, the method comprising:
at a computing device of a distributed artificial intelligence (AI) inferencing platform, estimating an estimated prompt load and an estimated generation load of an AI inferencing workload to be fulfilled by a processing unit of a computing node of the distributed AI inferencing platform, based at least in part on a sample workload associated with a same user as the AI inferencing workload;
based at least in part on the estimated prompt load and the estimated generation load, estimating an inference unit (IU) processing load via a statistical model, the IU processing load to be applied to the processing unit while fulfilling the AI inferencing workload; and
allocating fractional processing capacity of the processing unit for fulfilling the AI inferencing workload based at least in part on the IU processing load.
